(19) United States
(12) Patent Application Publication
(10) Pub. No.: US 2006/0049116 A1
(43) Pub. Date: Mar. 9, 2006

(54) Method and apparatus for bubble glow discharge plasma treatment of fluids

(76) Inventor: Krupakar M. Subramanian, Boise, ID (US)

Correspondence Address: Wilson Daniel Swayze, Jr, 3804 Clearwater Ct, Plano, TX, 75025, US

(21) Appl. No.: 11/220,230

(22) Filed: Sep. 6, 2005

Related U.S. Application Data
(60) Provisional application No. 60/607,271, filed on Sep. 7, 2004.
(60) Provisional application No. 60/607,039, filed on Sep. 3, 2004.

(51) Int. Cl. C02F 1/46

(52) U.S. Cl. 210/748

(57) ABSTRACT

A method for changing the chemical properties of fluid media is carried out in a coaxial plasma reactor. The plasma reaction in the reactor produces reactive species, such as electrons, ions and free radicals that promote better flammability of the combustible liquids, helps isolates unwanted pollutants such as sulfur and nitrogen by forming heavier compounds and also helps inactivate any microorganisms in other fluids such as water. In various embodiments, the plasma reaction also sputters off minute particles from the interior surfaces of plasma reactor. Such nanoparticles helps lower the combustion temperature of the flammable fluids and disinfect other fluids such as water. In another embodiment, breaking the bubbles into smaller size using an ultrasound generator increases the efficiency of the plasma reactor. In another embodiment, the bubbles are broken into smaller size and mixed with the fluid by agitating the liquid using a mechanical stirrer. In another embodiment, the ionization of the gases within the fluid is promoted by DC, pulsed DC, RF power applied to two electrodes. In another embodiment, an inductively coupled coil placed either outside or inside the chamber promotes the plasma generation within the bubbles. Various applications of this device include pre-treatment of the fuel before injecting it into an internal combustion engine to decrease the exhaust pollution and also decrease the combustion temperature, disinfection of drinking water, sewage treatment etc.

### PRIORITY

The presently claimed invention claims priority based on provisional applications Ser. Nos. 60/607,271 filed on Sep. 7, 2004 and 60/607,039 filed Sep. 3, 2004.

### FIELD OF THE INVENTION

The present invention relates generally to the generation of plasma discharge and, more particularly, to an apparatus for generating discharges within bubbles introduced into fluids to purify and/or decontaminate the same.

### DESCRIPTION OF THE RELATED ART

Plasma fluid treatment has a great commercial promise for reducing exhaust pollution by purification of gasoline, diesel, alcohols, flammable and non-flammable materials, changing the reactive properties of a liquid media for applications such as improving the fuel efficiency of the automobiles, and disinfecting dense fluids such as water.

Purification is defined as the process of reduction or elimination of unwanted material either directly or along with other materials in the form of chemical compounds. Disinfection is defined as the killing or inactivation of disease-causing organisms.

Due to the adverse effects on air quality, the Environmental Protection Agency (EPA) is very concerned about controlling particulate emissions from diesel trucks and buses. Very stringent, federal emissions standards are scheduled to take effect in late 2005. New US EPA Tier 2 Regulations on sulfur content in diesel and gasoline are:
Most refiners must meet a 30 ppm sulfur average with a 80 ppm cap for both conventional and reformulated gasoline by Jan. 1, 2006
New on-road diesel regulations=15 ppm sulfur cap by Jan. 1, 2006

The particulate matter (PM) also known as soot, is generated in both gasoline and diesel-powered engines. These engines create the undesired chemical compounds from the combustion of hydrocarbon-based fuels (fossil fuels). These compounds then cluster together in particle form to create the soot, which is released into the air as exhaust. Soot is also generated as an indirect byproduct of oxides of nitrogen (NOₓ) and sulfur (SOₓ) reacting in the atmosphere. Soot's composition often includes hundreds of different chemical elements, including sulfates, ammonia, nitrates, elemental carbon, condensed organic compounds, and even carcinogenic compounds and heavy metals such as arsenic, selenium, cadmium and zinc.¹

Conventional diesel engines in general release more soot than their conventional gasoline counterparts. This has to do with the way fuel is injected and ignited: in gas engines, fuel is injected during the intake stroke and ignited with a spark; whereas in diesel engines the fuel is injected during the compression stroke, and the fuel ignites spontaneously from the pressure. As a result, gas engines have two emissions advantages. The ignition process is more carefully controlled and the air and fuel are more thoroughly mixed before ignition occurs, thereby reducing the amount of un-burnt fuel. In a conventional diesel engine, the fuel is injected late in the cycle and the air is not as well mixed as in a gasoline engine. As a result of this less homogeneously mixed fuel and air, there are fuel-dense pockets in the combustion chamber. The consequence is that diesel engine exhaust contains incompletely burnt fuel known as particulate matter (soot). But it's not “engine-out” pollution that really matters—it's what comes out of the tailpipe. One way to reduce pollution is to burn fuel completely before exhaust (using catalytic converters), however this will not reduce the SOx & NOx contents significantly. Gasoline engines have gotten a lot cleaner over time through the use of add-on pollution controls, like catalytic converters. The EPA has passed increasingly stricter standards for gasoline engines, and as a result, catalytic converters are now standard on every new gas car. The soot standard for diesel cars under EPA's Tier 1 regulation has been at least ten times the average emission from a gasoline car (a major drawback). But under the new Tier 2 regulations, which will phase in between 2005 and 2009, diesel engines will finally have to meet the same strict standard as gasoline cars.

Diesel cleanup technology has come a long way. From diesel particulate traps to oxidation catalysts, there are now various methods of catching or converting much of diesel pollution before it escapes the tailpipe. Starting in 2009, all diesel light trucks and cars will have to meet the same tailpipe standards as gasoline vehicles. But new engine standards alone are not enough to protect the public from diesel pollution. New standards for diesel engines will be slowly phased in over the next 10 years. Plus, the durability of diesel engines means that older, high-polluting vehicles can continue to operate for decades. Diesel soot emissions are furthered by the fuel itself, as today's conventional diesel fuel contains significantly more sulfur than does gasoline.³

Worldwide, diesel engine powered ships are also a leading source of smog-forming NOx and SOx. Their exhaust contains dozens of known carcinogens and is high in particulate matter, fine particles of pollution that lodge in the lungs and can cause asthma, respiratory problems and premature death. From the Northwest to the Gulf of Mexico, ships are now a significant and growing source of air pollution. The federal government estimates global shipping will double or triple by 2020. In 15 years, the EPA projects, ships will account for at least a quarter of the dirty-particle exhaust produced by all vehicles in the Puget Sound region.² The vessels are powered by low-quality diesel bunker fuel, so dirty each particle of exhaust legally can be 3,000 times higher in sulfur than the fuel soon to be used by new diesel trucks. Even industry lobbyists have said international ship-fuel standards for sulfur, a primary component of acid rain, are ridiculously high. Ships in the Los Angeles/Long Beach ports already produce nearly as much smog as Southern California's 350 largest industrial polluters combined. An estimated one in every 1,000 residents who have lived in nearby neighborhoods their entire lives may contract cancer from the bad air.² Also, in Santa Barbara the total air pollution is expected to get worse even as cars, trucks, trains and buses get cleaner. The reason: Ship emissions are getting worse faster than other sources of pollution are getting cleaned up.

New technologies have to be developed that would help remove or mitigate the pollution from the diesel engines of all kinds. Although many “add on” techniques are available that post-treat the exhaust gases from a diesel engine, they are still not very efficient. Besides, it is highly recommended that the low sulfur content diesel be used for many add-on catalytic converters. Although many diesel purification techniques are under investigation and some of them are pending implementation, most of these techniques have some form of disadvantage associated with them. Such techniques require further investigation and innovation to overcome the associated problems. No single design is capable of removing all the pollutants and hence a combination of such solutions is used to address the diesel pollution issue and is adapted in the proposed technique as appropriate.

Another issue with hydrocarbon fuels is that, the fuel if exposed to atmosphere tends to react with the ambient gases and produce unwanted gums and other byproducts, thus worsening the problem further. FIG. 6 illustrates one such prior art device.

In the present invention a new technique is described that uses plasma generated within the gas bubbles introduced into the fluid to change the properties of the fluids such as fuels and disinfect other fluids such as water.

### SUMMARY

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

A new technique is described that would treat the fluids for various applications (such as pre-treatment of fuels before injecting it into an internal combustion engine). This technology would reduce the sulfur content in the fuel before combustion and hence the engine's exhaust (primarily soot) would have significantly less sulfur content as well. With some modifications to the proposed technique, new avenues might open-up, which could potentially lower the combustion temperature of the fuel thereby increasing the overall efficiency of the diesel engine, besides reducing the pollution content. Since the present technique is an “add-on” type technology it has universal applicability (to any diesel engine). With modification, it can even be adapted to help reduce the emissions from the conventional gasoline engines. Low cost is another attractive feature of this device. The same device can also be used to disinfect fluids such as water.

The glow discharge generated within the gas bubbles in accordance with the teaching of the present invention introduced into the fluid, uniformly releases activated species into the fuel that removes impurities (e.g., sulfur). The nanoparticles released into the fuel by the sputtering action of the plasma on the walls of the chamber, stirrer and the electrodes decreases the flammability temperature of the fuel thus aiding easy combustion thus help decrease the nitrogent oxides (NOx) generation.

The present invention provides significantly improved efficiencies of impurity removal from hydrocarbon fuel (e.g., diesel, gasoline). The present method also helps disinfect fluids (e.g., water) of harmful microbes. Since the plasma is generated within the gas bubbles within the fluid, the transient species generated inside these bubbles come in contact with the dense fluid wherever the bubbles move.

In accordance with the present invention, which may be denoted as Bubble Glow Discharge Plasma (BGDP) fluid treatment, the BGDP is generated within the fluid through either a capacitive or inductively coupled radiofrequency (RF) discharge using appropriate electrode arrangements as described later. Other modes of BGDP generation include the use of constant or pulsed voltage applied to at least one conductive surface of the enclosure containing the coaxial electrodes (from now on referred to as coaxial chamber) with respect to the other.

The gases within the said bubbles comprise of predominantly steam (H₂O in the vapor form) especially for diesel and gasoline treatment. Other gas mixtures that could be used are noble gases, hydrocarbons, fluorocarbons, vaporized fluids or solids, tiny (very small) droplets of fluids, very small particles of solids and any mixtures thereof. Fluid is introduced into the coaxial chamber preferably through at least one opening at the bottom of the coaxial chamber. The gases are also introduced into the said fluid from the bottom of the chamber through the same openings used to introduce the fluids or through at least one other opening. The relative size of the opening could be easily determined according to the size of the chamber by the one with ordinary skill in the art. In one embodiment of this invention the gas used is at least 5% by volume of steam or tiny droplets of water (more generally called the H₂O gas), the rest of the volume could be any or all of the above-mentioned gases. Of course water can also be converted into minute droplets and suspended in gases by ultrasound generators and subsequently fed to the coaxial chamber. Hence the steam may be more generally referred to as H₂O gas.

The bubbles preferably introduced into the fluid from the bottom rise upwards due to the difference in the weights of the gases and the fluid. These bubbles may be stirred using a plurality of rotating propellers arrangement, described later. Also, setting up sound waves in the fluid media using an ultrasonic transducer breaks the bubbles into smaller size bubbles. This is done to effectively mix the bubbles and the fuel thus exposing larger portions of the diesel to the bubbles. The frequency of the transducer can be controlled using external controls and could be optimized for the size of the chamber accordingly. The breakdown of the bubbles into smaller constituents increases the surface area of the diesel exposed to the plasma. The inner surface of the chamber may be lined with insulators (such as Al203, Si3N4, Polymers, Nylon, Teflon, Polyvinyl Chloride, etc.,) if the liquid is highly conductive, otherwise metallic tubes (made of Fe, aluminum, stainless steel of all compositions e.g. SS403, various metal alloys etc.) could be used in direct contact with the fluid. The insulation could either be lined along the interior of the outer electrode (wall) or the exterior of the inner electrode (wall) or both. The top and bottom plates may also be used as electrodes for the application of the RF power.

If the amount of fluid introduced into the coaxial chamber is held constant for a relatively long duration (longer than 5 s) while the gases are introduced during this time and ionized using any of the technique mentioned below, most of the fluid within the coaxial chamber will come in contact with the plasma generated within the bubbles. This would help remove the impurities (unwanted compounds such as Sulfur) from the fluids efficiently (in greater quantities). Another way to improve the efficiency would be to stir the fluid more vigorously during the BGDP treatment of the fluids. The one with ordinary skill in the art can easily determine the appropriate rotational speed of the stirrer empirically. Of course a relief value or a provision such as a tube connected to a vacuum pump or simply open to atmosphere would have to be used to remove the gases from the coaxial chamber. Such provisions would be introduced preferably on the top plate of the chamber.

In one embodiment of this invention the steam for purifying gasoline, diesel or other dense fluid media is generated externally using any of the available boilers placed outside the chamber. Subsequently, the gases are ionized before they are released from the fluid.

In one embodiment, the gases are ionized using direct current (DC) voltage applied between the coaxial chamber walls. In another embodiment the DC voltage is applied between the top and bottom plates of the chamber. In another embodiment the DC voltage is applied between any two of the plates (top and bottom) and the electrodes (inner or outer) and any combinations thereof.

In another embodiment, a pulsed voltage generator replaces the said DC voltage. In another embodiment of this invention, the RF power is applied to at least one bare or insulated electrode. The appropriate RF frequency and amplitude (RF source strength) required for the present purpose (of ionizing the gases within the bubbles) can be determined experimentally (empirically) by the one skilled in the art. The RF source strength required for the BGDP treatment of fluids will depend on various parameters such as the bubble size, chamber pressure, kind of fluid, fluid temperature, the dimensions of the chamber, etc.

In another embodiment of this invention, the RF power is applied to at least one electrically insulated conductive coil wound around the coaxial chamber. The insulation required for this coil may be used either directly around the wire or around the chamber or both. This coil may be placed inside the chamber if desired.

The fuel after BGDP treatment is sent through an adsorption unit that separates heavy pollutant compounds such as (sulfoxides and sulphones) from the fluids such as diesel and gasoline. The fuel at this point would still contain some condensed water and particulates that can be easily separated from the fluid using the commercially available centrifuge based diesel polishing unit manufactured by SMS Ltd.³ The fuel is then either immediately fed to the inlet nozzle of the IC engine or stored for future use.

In another embodiment of this invention, the nanoparticles sputtered off from the surfaces of the chamber walls by the bubble plasma helps further reduce the soot formation and might even improve the fuel efficiency. Nanoparticles made of platinum, Iron, Aluminum, nickel, chromium, silver or any mixture combination thereof, could help improve the fuel efficiency, but platinum nanoparticles may have the best chance to succeed. For this purpose, it might be economical to coat the surfaces interior to the coaxial chamber with the desired metals (e.g. Platinum). The fuel with various concentrations of nanoparticles once atomized inside the IC engine's combustion chamber would allow ignition of the fuel at relatively lower temperature and help reduce the formation of unwanted exhaust pollutants (e.g., NOx). Since pollutants generally form at higher combustion temperatures and by simply lowering the ignition point of the fuel one could reduce or even eliminate the formation of such pollutants.

A significant advantage of this invention is that it is lightweight, uses relatively less power and that it can be used in automobiles without any further modifications to the engine's design (is an add-on technology).

This invention also has other applications; it can be used as a fluid (e.g. water) purifier by simply replacing the fuel in the coaxial chamber with the desired fluid and generating plasma within the gas bubbles introduced into the medium.

In another embodiment of this invention, the device is used to inactivate or disinfect dense fluids such as water. The levels to which pollutants microbial colony forming units are permitted in various waters fit for human contact is carefully regulated. The pulsed high-voltage discharge-mediated formation of chemical species and their effects has also been studied. However, the uncontrolled streamline discharges produced in such pulses do not yield a uniform supply of activated species for changing the properties of the fluid uniformly and also lack adequate controllability. The invention will be able to produce uniform BGDP inside the fluid would provide a steady supply of activated species that would help disinfect the fluid. It would be preferable to make at least some parts of the interior of the chamber with silver to further improve the disinfection efficiency of the device The present invention uses alternate ionization techniques and is also applicable for the treatment of other fluids (e.g., diesel, gasoline etc.).

### BRIEF DESCRIPTION OF THE DRAWINGS

The invention may be understood by reference to the following description taken in conjunction with the accompanying drawings, in which, like reference numerals identify like elements, and in which:

FIG. 1 shows a schematic drawing of the cross-section about the A-A′ plane as shown in

FIG. 2 shows a multistage mechanical fluid stirrer;

FIG. 3 shows a cross-section view of the coaxial chamber across the 1′-1′ plane shown in FIG. 1;

FIG. 4 shows a simplified flow plan;

FIG. 5 shows a schematic diagram of the proposed fluid purifier;

FIG. 6 shows a commercially available centrifuge based diesel purifier called a diesel polishing unit³ for the removal of condensed water and other particulates; and

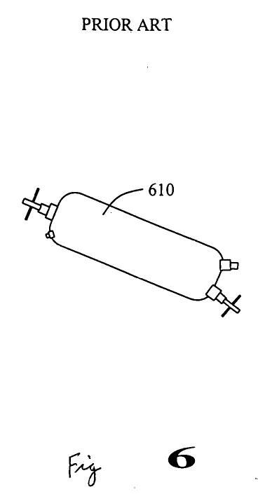

FIG. 7 shows an alternative diesel purifier that generates inductively coupled BGDP.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

This disclosure of the invention is submitted in furtherance of the constitutional purposes of the U.S. Patent Laws “to promote the progress of science and useful arts” (Article 1, Section 8).

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another.

The present invention will now be described with reference to the attached figures. Additionally, the relative sizes of the various features and structures depicted in the drawings may be exaggerated or reduced as compared to the actual size of those features or structures. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

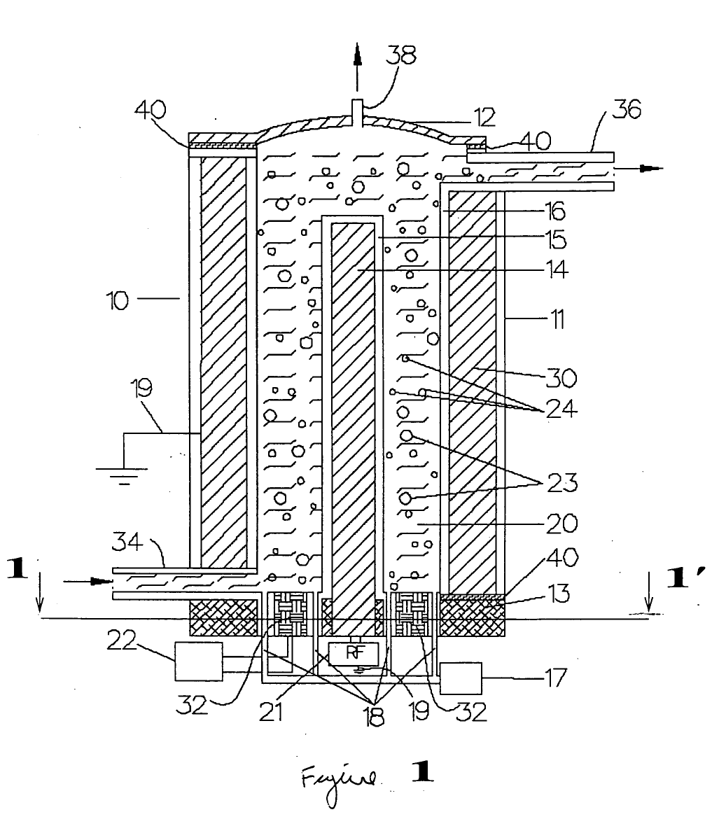

With reference to the drawings, a BGDP fluid treatment chamber in accordance with the present invention is shown generally at 10 in partial cross-section in FIG. 1. The apparatus 10 includes an enclosing chamber 11 having preferably non-conductive walls, e.g., polyvinyl chloride (PVC), plastic, Teflon or other suitable material, which may be formed, as shown, with a preferably dome shaped conductive top plate 12, isolated from the rest of the chamber by the insulation 40, a bottom plate 13 which may be flat. It is preferable to make the bottom plate of non-conductive materials but if metal is used, it may have to be isolated from the rest of the chamber, an input port 34 to input fluid such as fuel including diesel or gasoline and a first output port 36 to output the fluid and a second output port 38 that is substantially in the center of the top plate 12 that can be used to regulate the gas pressure inside the chamber and act like a vent to remove the used gases. Of course other provisions can be added to separate the used gases from the vapors of the fuel. In one embodiment of the invention a vacuum pump together with a valve placed at or around the second output port 38 is used to regulate the pressure inside the chamber through a port on the top of the coaxial chamber.

A central electrode 14 is shown substantially coaxially into the chamber 11. In another embodiment of this invention, the geometry of the coaxial chamber may be replaced by a parallel plate arrangement placed inside an enclosing container with or without insulating layers along the fluid facing components.

In another embodiment of this invention, the central electrode 14 could be inserted from the top and appropriate insulation is provided to isolate the electrode 14 from the other conducting parts of the chamber. An insulating layer 15 surrounds the inner electrode 14, while another insulating layer 16 surrounds the inner surface of the outer cylindrical electrode 30 as shown. A pressure pump 17 is connected to the inlet tubes 18 and operates to populate the chamber 11 with gas bubbles 23, 24 (typically around one atmospheric pressure or higher) in a controlled fashion. It is preferable that all of the chamber walls 12, 13, 14 and 30 of the chamber 11 may be electrically isolated. Preferably, an electric line 19 to ground connects the outer electrode 30. The central electrode 14 is connected to one terminal of the RF power supply 21 as shown, while the other terminal is connected to ground through an electric line 19 or is directly connected to the outer electrode 30. The initial size of the bubbles may be controlled by varying the size of the openings (nozzle) of the tubes 18. As the bubbles 23, 24 rises up in the chamber, the ultrasonic vibrations setup in the chamber by the piezoelectric oscillator 32, controlled externally using an oscillator 22 that breaks the larger bubbles 23 into smaller bubbles 24 thus increasing the surface area of the plasma exposed to the fluid. Of course, the sound waves transmit through any material media hence the piezoelectric oscillator 32 can be arranged and positioned in any number of ways within the chamber 11 or even outside the chamber 11, for example, along the outer surface of the central electrode 14, inside the central electrode 14, along the inner surface of the outer electrode 30, inside the outer electrode 30 or outside the outer electrode 30. These examples by no means encompass all the possibilities of ionizing and breaking bubbles, but are stated for illustrative purposes only.

The present device can also be operated by grounding the central electrode 14 while applying the RF signal to the outer electrode 11 after providing additional insulation around the outer electrode. The RF signal applied to the inner electrode 14 provides an oscillating electromagnetic field that ionizes the gases within the bubbles. Other methods of ionizing the gases within the bubbles include the use of ionizing radiation for example ultraviolet or X-rays, that may be introduced into the chamber through a port conveniently located on either or both of the top and bottom plates 12 and 13, or coaxial electrodes 14 and 30, such ports may not be required if x-rays are used, since x-rays being inherently material penetrating rays. Such an x-ray unit could be stationed outside the chamber.

The transient species generated by the BGDP within the bubbles 23 and 24 typically consists of the ionized, excited and neutral species of the gases along with the fluid (e.g., diesel, gasoline etc.,) vapors, and are released into the fuel everywhere the bubbles 23 and 24 move inside the fluid within the chamber 11. Such transient species (e.g., hydroxyl ions and radicals) are generally very reactive and help remove pollutants (such as sulfur) by forming heavier compounds (sulfoxides & sulfones) that can be removed from the fluid using any of the available techniques e.g., adsorbing agents. The transient species and the sputtered nanoparticles from the inner surfaces of the coaxial chamber exposed to the diesel also helps bring down the ignition temperature of the fuels, and also help disinfect the fluids when water is used.

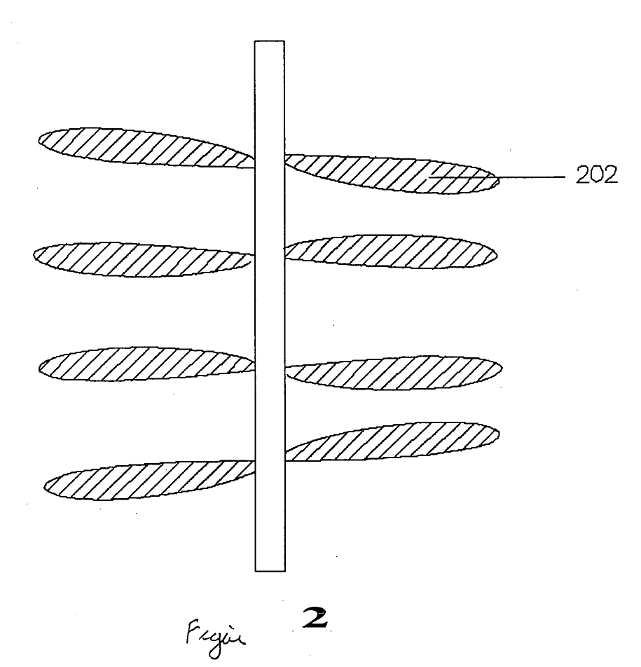

The efficiency of the present device can be further improved by providing a stirring mechanism 202 shown in FIG. 2 that would replace the central electrode 14 in FIG. 1. The stirrer enables the bubbles to stray and mix with the liquids. Also, a vent 38 may be provided in the top wall 12 to collect the gas, if it is desired not to inject such used gases back into the coaxial chamber, otherwise such gases could be recycled.

The processed fuel would still contain pollutants such as condensed water and particulate contaminants. Therefore a commercially available centrifuge system connected to the outlet of the adsorbing unit removes any residual contaminants (such as condensed water, heavier particulates etc.,) from the fluids (e.g., diesel) before storing it or injecting it immediately into the engine. Thus the present invention enhances fuel efficiency, improves reliability, and decreases SOₓ, generation. Since this device treats the fuel and not the exhaust, the fuel could be preprocessed soon after filling the fuel tank; hence continuous running during the regular engine operation is not required. This directly translates into decreased energy consumption and operational costs. Also, such units could be installed in pump-stations and oil refineries, besides directly mounting them on the automobiles.

In addition to the above-mentioned features, the system design includes the plasma generation scheme that can be adapted for many other applications where the fluids are desired to be more reactive at smaller concentrations to make the process more environmentally friendly and economical. Such applications include but are not limited to chemical dyeing, leather industry, sewage treatment, medical applications, chemical industries etc. This technique helps replace harmful environmentally unfriendly chemicals with harmless or less environmentally unfriendly materials.

The present BGDP system can be either used as a stand-alone purifier installed on the vehicle itself or installed in a refinery. It is however advantageous to have the system installed on individual vehicles because the fuel gets treated just before injecting into the engine.

The RF power supply used is a low frequency in the range of 1-500 kHz, at 1-1000 W, that is capable of producing atmospheric pressure plasma⁴ Plasma source characteristics for the one atmosphere uniform glow discharge plasma (OAUGDP) in characteristic working gases have been measured⁴ for He, Ar, N₂O, CO₂ and could be used as starting points determining the appropriate RF source strength for steam+gas mixtures.

| Characteristics | Units | Low | Characteristic | High |
|---|---|---|---|---|
| Frequency, νₒ | kHz | 0.5 | 5 | 40 |
| Voltage, Vᵣₘₛ | kV | 1.5 | 7 | 18 |
| Electrode gap, d | cm | 0.2 | 0.4 | 2.8 |
| Electric field, Eᵣₘₛ | kV/cm | 2 | 8.5 | 12 |
| | | | (air) | |
| Gas pressure, p | Torr | 755 | 760 | 775 |
| Power to plasma, p | W | 10 | 200 | 2000 |
| Power density, \overline{P} | mW/cm² | 4 | 100 | 600 |
| Plasma volume V | liters | 0.03 | 0.2 | 2.8 |
| Electron density, nₑ | No./m³ | | ˜10¹⁶ | |
| Electron energy, Tₑ | eV | 1 | 4 | 20 |
| Ion energy, Tᵢ | eV | 0.025 | 0.025 | |

The critical frequency v, above which the uniform glow discharge usually builds up in the plasma is given by:⁴

$${v}_{o} \approx \frac{{eV}_{rms}}{π \cdot {mv}_{c} {d}^{2}} Hz \qquad Eqn . 1$$

where v_{c} is the collision frequency and m the mass, of the species of interest.

Since the chamber is operated close to atmospheric pressure, a RF source is selected that is capable of ionizing at least one-atmosphere pressure gases. The Eqn. 1 can be used to select the approximate range of operation of the RF power supply depending on the availability. The peak to peak voltage and correct frequency range of operation (source strength) is then determined empirically to produce BGDP as it is dependent on various parameters such as the chamber dimension, operating pressure, gases used, speed of the stirrer, chemical composition of the fluid & chamber walls, etc. Once the appropriate source strength (frequency and the peak-to-peak voltage) is determined by the one skilled in the art using any of the existing device optimization techniques, an RF generator producing fixed frequency source strength can be used, since such fixed source strength generators are relatively inexpensive.

In compliance with the statute, the invention has been described in language more or less specific as to structural and methodical features. The particular embodiments disclosed above are illustrative only, as the invention may be modified and practiced in different but equivalent manners apparent to those skilled in the art having the benefit of the teachings herein. For example, the stirring action performed by a set of four propellers (as shown in FIG. 2) can be accomplished by other means such as differently shaped propellers or more number of propellers or several propellers operated in tandem placed in different regions of the chamber or propellers attached to the inner wall of the chamber and then rotating the chamber with respect to the central axis.

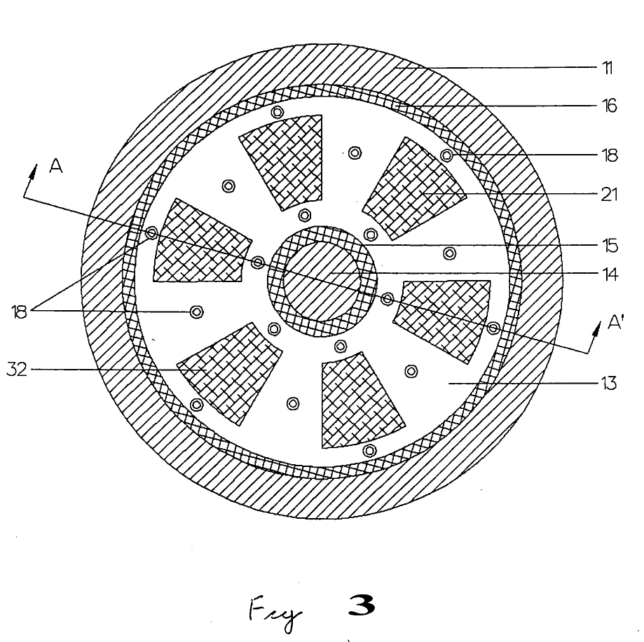

FIG. 3 illustrates a cross-sectional view of the BGDP fluid treatment chamber 10 as illustrated in FIG. 1. The central electrode 14 in the corresponding insulating layer 15 is shown as having a circular cross section, but other geometries are within the scope of the present invention. The bottom wall 13 includes inlet tubes 18 and piezoelectric oscillator 32, the insulating layer 16, and the enclosing chamber 11 are shown with circular cross-section, but other geometries are within the scope of the present invention.

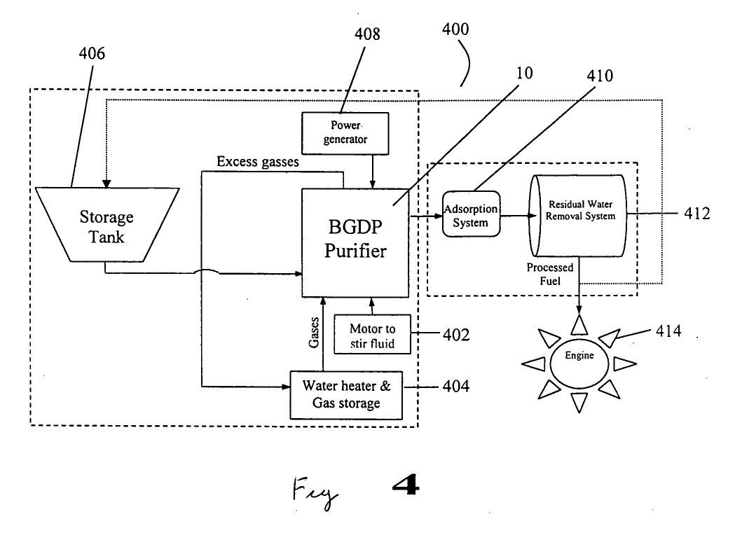

FIG. 4 illustrates a system 400 employing the BGDP purifier 10. A fuel tank 406 supplies fuel to the purifier 10, which receives steam (& other gases) from the water heater (& gas storage) 404 to provide steam to the purifier 10. Excess steam is removed from the purifier 10 and recycled back to the water heater 404 or simply vented to atmosphere. An RF, DC, Pulsed, or Inductive Power generator 408 supplies power to the purifier 10 in order to generate BGDP to purify the fuel supplied to the purifier 10. The now purified fuel which is output from the purifier 10 is received by the adsorption system 410 in order to remove the heavier impurities formed during the BGDP treatment from the fuel, and the fuel is output from the adsorption system 410 and inputted into the residual water and particulate removal system (commercially available diesel polishing unit³) 412 to remove residual water and particulates from the fuel entering the residual water removal system 412. The processed fuel from the residual water removal system 412 is now substantially free of pollutants (e.g., sulfur) to be used by an engine. As shown in FIG. 4, the processed fuel enters the engine 414 or is sent back to the storage tank 406 or a separate tank (not shown in the FIG. 4) for storage. If the fuel were sent back to the storage tank 406 then special provisions would have to be made to the storage tank 406 to keep the purified and unpurified fluids separate. One such technique would be to use a fluid tight piston like arrangement that can slide from one end of the tank to the other about a central shaft placed coaxial with the container cylindrical tank for keeping the purified and unpurified fuels separate. If water were the fluid that is being purified using the BGDP purifier 10, the adsorption system 410 and the residual water removal system 412 will not be necessary.

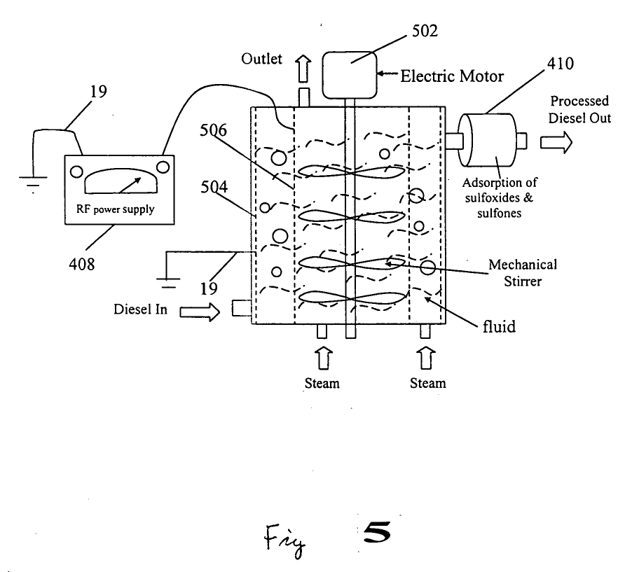

FIG. 5 illustrates the schematic diagram of a mechanical stirrer 202 used to stir the fluid within the purifier 10, and the mechanical stirrer 202 is turned by an electric motor 502. In one embodiment, the orientation of the propellers cancels out any substantially directional flow of the fluid. FIG. 5 additionally shows the adsorption system 410 to remove or adsorb sulfoxides and sulfones from the fuel. In an embodiment of the present invention the enclosing chamber of the BGDP purifier is made of non-conducting materials and hence at least one co-axial metallic tube would have to be used. FIG. 5 shows two such tubes 504 and 506. These tubes could also be porous to enable the fluids to mix. The stirrer 202 would still mix the fluid and the bubbles and the RF power is applied between the two coaxial tubes 504 and 506 or one coaxial tube (504 or 506) and the stirrer 202, if the stirrer 202 is substantially made of conducting material.

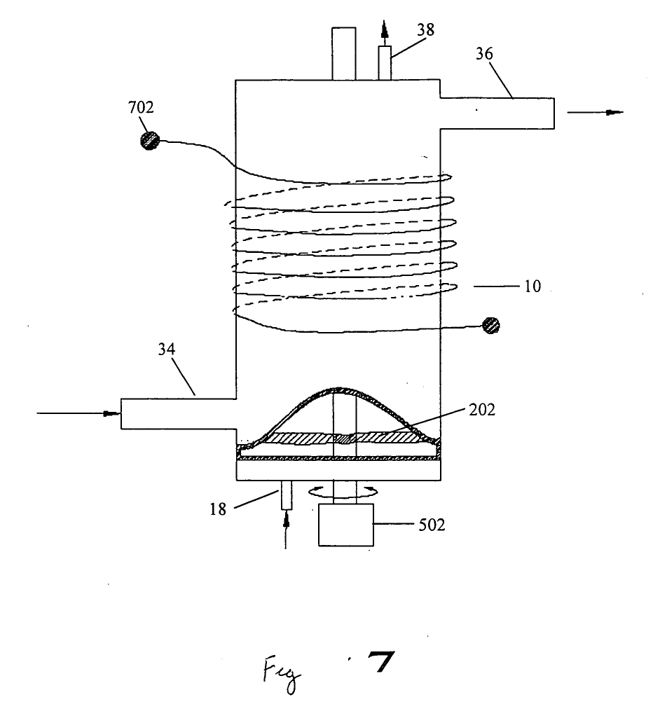

FIG. 7 illustrates an alternate scheme for BGDP treatment of the fuel within the purifier 10. In more detail, FIG. 7 illustrates a coil 702, which is shown as being coiled around the purifier 10. The coil itself is electrically isolated from the chamber walls if the walls are conducting. The RF power is applied to at least one coil 702 placed either outside or inside the coaxial chamber to generate inductively coupled BGDP plasma within the gas bubbles in the purifier 10.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed. Hence, it is to be understood, however, that the invention is not limited to the specific features shown and described, since the means herein disclosed comprise preferred forms of putting the invention into effect. The invention is, therefore, claimed in any of its forms or modifications within the proper scope of the appended claims. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention

What is claimed is:

1. An apparatus for purifying and changing a fluid comprising:
a first input port to input said fluid into an enclosure;
a second input port to input gases into the fluid within the said enclosure that forms bubbles;
an apparatus to agitate the gas within bubbles within the said fluid;
an apparatus for ionizing said gases within the bubbles within said fluid;
a first output port to output the said gases after use;
a second output port to output said fluid after treatment from said enclosure;

2) An apparatus for purifying and changing a fluid as in claim 1, wherein said agitating apparatus generates an ultrasound signal to agitate and break the said bubbles into smaller bubbles and mix the said bubbles with the said fluid.

3) An apparatus for purifying and changing a fluid as in claim 1, wherein said agitating apparatus includes a stirring element to agitate said bubbles into smaller bubbles and mix the said bubbles with the said fluid.

4) An apparatus for purifying and changing a fluid as in claim 1, wherein said apparatus generates bubbles of various sizes.

5) An apparatus for purifying and changing a fluid as in claim 1, wherein said purifying apparatus includes a pressure pump to generate said bubbles.

6) An apparatus for purifying and changing a fluid as in claim 1, wherein said fluid includes a combustible fluid.

7) An apparatus for purifying and changing a fluid as in claim 7, wherein said fluid includes at least one of diesel and gasoline fuel.

8) An apparatus for purifying and changing a fluid as in claim 1, wherein said fluid includes a non-combustible fluid.

9) An apparatus for purifying and changing a fluid as in claim 1, wherein the pressure inside the said apparatus is controlled through at least one valve.

10) An apparatus for purifying and changing a fluid as in claim 1, wherein said apparatus includes a boiler to generate the steam bubbles.

11) An appuratus for purifying and/or changing the said fluid as in claim 1 by agitating and mixing the particles sputtered off from the inner surfaces of the said enclosure by the plasma generated within the said bubbles within the said fluid.

12) An apparatus for purifying a fluid as in claim 1, wherein said fluid includes bubbles including the gases.

13) An apparatus for purifying and changing a fluid as in claim 12, wherein said bubbles includes at least one of the fluorocarbons, H₂O gas, hydrocarbons, noble gases, vapors and/or minute droplets of the said fluid and/or other fluids, and vapors and/or minute particles of solids.

14) A method for ionizing the said bubbles within the said fluid, comprising the steps of:
inputting said fluid into an enclosure and introducing gases in the form of bubbles into the said fluid,
agitating said fluid along with the said bubbles;
ionizing the gases in the bubbles within said fluid to purify the said fluid,
ionizing the gases in the bubbles within said fluid to change the chemical properties of the said fluid,
outputting said fluid.

15) A method for ionizing the gases within the said bubbles as in claim 14, wherein the method includes a voltage applied to at least one conducting surface of the said apparatus.

16) A method for ionizing the gases within the said bubbles as in claim 14, wherein the method includes applying a pulsed voltage to at least one conducting surface of the said apparatus.

17) A method for ionizing the gases within the said bubbles as in claim 14, wherein the method includes applying a RF power to at least one conducting surface of the said apparatus.

18) A method of ionizing the said gases within the said bubbles as in claim 14, wherein the said apparatus includes a conductive surface being covered by a non-conductive material.

19) A method for ionizing the gases within the said bubbles as in claim 15, wherein the method includes applying a RF power to at least one insulated or bare coil placed outside the said apparatus.

20) A method for ionizing the gases within the said bubbles as in claim 15, wherein the method includes applying a RF power to at least one insulated or bare coil placed inside the said apparatus.
